(19) United States
(12) Patent Application Publication
(10) Pub. No.: US 2004/0202063 A1
(43) Pub. Date: Oct. 14, 2004

(54) Optical disk apparatus

(76) Inventors: Osamu Mizuno, Osaka-shi (JP); Tohru Nakamura, Katano-shi (JP); Hideki Aikoh, Higashiosaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/819,170

(22) Filed: Apr. 7, 2004

(30) Foreign Application Priority Data
Apr. 9, 2003 (JP) 2003-105066(PAT.)

(51) Int. Cl. G11B 7/00; G11B 7/135

(52) U.S. Cl. 369/30.46; 369/44.11; 369/44.27; 369/112.01

(57) ABSTRACT

An optical disk apparatus is provided which is capable of certainly preventing an optical disk from coming into contact with an objective lens, even when its power is kept turned off and servo control is not in operation, and preventing an optical disk from hitting the objective lens, even though it undergoes a strong disturbance. A cartridge 2 includes an opening portion through which an objective lens 4 comes close to an optical disk 1 and a rib 2b which is formed near the cartridge outer-edge connection part of the opening portion; the plane of the rib 2b on the side of the objective lens 4 is substantially on the same plane with the plane of incidence of the optical disk 1; when an optical disk apparatus 100 is turned off, a traverse mechanism 22 moves the objective lens 4 and a protective member 5 to a position P2 that faces the plane of the rib 2b on the side of the objective lens 4 when the cartridge 2 is housed in the optical disk apparatus 100.

### BACKGROUND OF THE INVENTION

1. Field of the Invention

The present invention relates to an optical disk apparatus in which, when the power of the apparatus is kept turned off, an optical disk and an objective lens can be prevented from being damaged when the one hits the other.

2. Description of the Related Art

In recent years, a demand for increasing the density of an optical disk has been made, which has prompted those skilled in the art to shorten the wavelength of a laser beam and heighten the NA (or numerical aperture) of an objective lens with respect to an optical head used for recording and replaying. However, objective lenses which have a large NA generally comes close to an optical disk, thereby shortening a so-called working distance (hereinafter, using its acronym, called WD). In addition, the smaller the size of such an apparatus becomes, the smaller the incident luminous-flux radius of an objective lens becomes. As a result, the WD becomes still shorter, and thus, some WDs have reached approximately 0.1 mm.

With respect to such a short WD, there is a fundamental disadvantage in that an objective lens inevitably hits an optical disk. Specifically, if the WD is shorter than the width by which the plane of an optical disk ordinary shakes, and unless servo control is executed, then when the optical disk rotates, the objective lens can come into contact with the optical disk, many times for a short period of time. This may instantly cause a big flaw or dent in them. As a result, their optical properties deteriorate, thereby bringing about some trouble in recording and replaying.

Aiming at coping with such a disadvantage, for example, there is shown an example in Patent Document 1. In this example, at the peripheral part of an objective lens, a protrusion is united with it on the side of a recording medium (or optical disk), so that the objective lens can be protected. In addition, for example, a similar example is disclosed in Patent Document 2.

The gist of these examples is to provide a portion which is located near the objective lens and protrudes from the objective lens, so that the optical disk can be prevented from directly bumping the objective lens.

FIG. 10 shows their essential part. FIG. 10 shows a conventional example in which an optical disk and an objective lens are disposed. In FIG. 10, reference numeral 1 denotes an optical disk; 4, an objective lens. A circular protective ring 5 is provided around the objective lens 4. The protective ring 5 is formed so that its front-end part is located above the top part of the objective lens 4. In other words, it is formed so that the objective lens 4 cannot protrude from the protective ring 5.

According to this configuration, the objective lens 4 cannot come into contact directly with the optical disk 1. Accordingly, the objective lens 4 cannot be damaged. Besides, if you properly select the material, or surface treatment, of the protective ring 5, you can reduce the possibility that the optical disk 1 may be damaged.

Herein, Patent Document 1 is Japanese Patent Laid-Open No. 9-63095 specification. Patent Document 2 is Japanese Patent Laid-Open No. 6-302001 specification.

However, the above described conventional optical disk apparatus has the following disadvantage. Specifically, when its power is kept turned on, servo control can evade their bump. But when the power is kept turned off with an optical disk inserted into the apparatus, servo control is not executed. This can create a state in which the protective ring 5 stays in contact with the optical disk 1.

For example, the focusing mechanism of an objective-lens actuator is usually out of balance over gravity. Therefore, in the case where the optical disk apparatus is portable equipment, as shown in FIG. 11, if it is turned upside down, then the objective lens 4 is displaced in a gravitational direction G by its own weight. Thus, the protective ring 5 can come into contact with the optical disk 1. If this state is kept as it is for a long time and condensation or the like is generated, then impurities or the like cling to the dew, and thereby, dirty spots may remain on the optical disk 1.

Furthermore, especially, in a portable optical disk apparatus, in the same way, if you turn off its power with the optical disk 1 kept inserted, then the objective lens 4 cannot stand up to a disturbance. This causes the objective lens 4 to shake freely, and thus, the protective ring 5 hits the optical disk 1 many times.

If you turn off the power of such portable equipment with a medium kept placed inside and carry it, that gives it a vibration. However, this practice is within normal use. In this case, their bumps can take place at one and the same part of the optical disk dozens of times per second, or hundreds of thousands times while it is carried for an hour, though that depends upon the natural resonance frequency of an objective-lens actuator or the like. Accordingly, the damage caused to the optical disk by the carriage could not be neglected.

Hence, conventionally, the above described measure to cope with such bumps has created condensation dirty spots on an optical disk, and the bumps while the power is kept turned off have generated some flaws in it. These matters deteriorate its optical properties, which has been a serious conventional problem.

### BRIEF SUMMARY OF INVENTION

In order to resolve the aforementioned disadvantages, it is an object of the present invention to provide an optical disk apparatus which is capable of certainly preventing an optical disk from coming into contact with an objective lens, even when its power is kept turned off and servo control is not in operation, and preventing an optical disk from hitting the objective lens, even though it undergoes a strong disturbance.

An optical disk apparatus according to the present invention, which includes at least an objective lens that converges and applies a laser beam onto an optical disk, a protective member that protects the objective lens, protrudes on the side of the optical disk from the objective lens and is disposed out of an optical effective range of the objective lens, and a traverse mechanism that moves the objective lens and the protective member, comprising, a rib which is disposed outside of the periphery of the optical disk and whose plane on the side of the objective lens is substantially on the same plane with the plane of incidence of the optical disk, wherein, when the optical disk apparatus is turned off, the traverse mechanism moves the objective lens and the protective member to the position that faces the plane of the rib on the side of the objective lens.

According to this configuration, even when its power is kept turned off and servo control is not in operation, an optical disk never comes into contact with an objective lens. In addition, even though it is subjected to a strong disturbance, an optical disk is not damaged. In other words, a superior optical disk apparatus is provided which enhances, simply and easily at a low cost, the long-term reliability of recording data. Moreover, even when the power is kept turned off and an optical disk remains inserted in the apparatus, the optical disk does not come into contact with the protective member. This prevents an optical disk from being dirtied and damaged because of the long-term contact of the optical disk with the protective member, as is often the case with a conventional optical disk apparatus.

Furthermore, preferably, in the above described optical disk apparatus: the optical disk is housed in a cartridge having an opening portion through which the objective lens comes close to the optical disk; and the rib is formed near an outer-edge connection part of on outer-side of the opening portion.

According to this configuration, the part near the outer-edge connection part of the opening portion of the cartridge which houses an optical disk is used as the rib. Hence, especially, there is no need to provide a rib, thus cutting off the number of production processes for providing a rib.

Moreover, preferably, in the above described optical disk apparatus, the rib is formed in a main body of the optical disk apparatus. According to this configuration, an optical disk is not housed in the cartridge, and thereby, even when the power is kept turned off and servo control is not in operation, an optical disk never comes into contact with the objective lens. In addition, even though it is subjected to a strong disturbance, an optical disk is not damaged. In other words, a superior optical disk apparatus is provided which enhances, simply and easily at a low cost, the long-term reliability of recording data.

In addition, preferably, in the above described optical disk apparatus, the traverse mechanism moves the objective lens to the position which faces the rib, after a demand to turn off the power is made and before the power is turned off. According to this configuration, before servo control comes into the state where it is not in operation, the objective lens can be placed below the rib. This makes it possible to certainly protect the objective lens and an optical disk.

Furthermore, preferably, the above described optical disk apparatus further comprises a focusing mechanism which moves the objective lens in the direction apart from the optical disk, before the objective lens passes through the optical disk and reaches the position that faces the rib. According to this configuration, the side plane of the objective lens can be prevented from bumping the side plane of the rib. This certainly prevents an actuator or the like which drives the objective lens from being damaged.

Moreover, preferably, the above described optical disk apparatus further comprises a focusing mechanism which moves the objective lens in the direction apart from the optical disk, after a demand to turn on the power is made when it is turned off and before the objective lens is moved in the radius directions of the optical disk from the position that faces the rib.

According to this configuration, the objective lens can be prevented from rubbing against the rib. Besides, the side plane of the objective lens can be prevented from bumping the side plane of the optical disk. This certainly prevents an actuator or the like which drives the objective lens from being damaged.

In addition, preferably, in the above described optical disk apparatus: the traverse mechanism moves an optical system which includes the objective lens in substantially the radius directions of the optical disk; the optical disk apparatus further comprises a control section which receives a power-on demand signal and a power-off demand signal, and which outputs a power-off signal to turn off the power, an objective-lens retreat signal to move the objective lens apart from the optical disk, and a traverse control signal to control the traverse mechanism; if the control section receives the power-off demand signal when the power of the optical disk apparatus is turned on, then the control section turns on the objective-lens retreat signal to move the objective lens apart from the optical disk, thereafter, outputs to the traverse mechanism the traverse control signal to move the objective lens fully up to the side of the outer circumference of the optical disk, turns off the objective-lens retreat signal after the objective lens is placed in the position that faces the rib, and outputs the power-off signal to turn off the power of the optical disk apparatus; and if the control section receives the power-on demand signal when the power of the optical disk apparatus is turned off, then the control section turns on the objective-lens retreat signal to move the objective lens apart from the rib, thereafter, outputs to the traverse mechanism the traverse control signal to move the objective lens in the direction of the inner circumference of the optical disk, and turns off the objective-lens retreat signal after the objective lens is moved in the inner-circumference direction of the optical disk.

According to this configuration, before and after the traverse mechanism moves, the control section controls the retreat signal to retreat the objective lens from an optical disk or the rib, according to whether the power of the optical disk apparatus is turned on. This can protect securely and automatically the objective lens and the optical disk, regardless of the state of the apparatus's power.

Furthermore, preferably, in the above described optical disk apparatus, the control section receives an operation state signal which shows whether or not information is being recorded, and if the control section receives the power-off demand signal when the operation state signal shows that information is being recorded, then the control section does not turn on the objective-lens retreat signal until the operation state signal changes and shows that information is not being recorded. According to this configuration, after information has been certainly recorded, the objective lens is retreated. This makes the apparatus easier for a user to handle, and also heightens the reliability of information.

Moreover, preferably, in the above described optical disk apparatus, the objective lens and the protective member are united. According to this configuration, the objective lens and the protective member are united, and thus, the objective lens and the protective member can be produced at a time, thereby reducing the number of processes for producing the apparatus. Besides, the objective lens and the protective member are united, and thus, the protective member can be prevented from falling off the objective lens.

According to the present invention, even when its power is kept turned off and servo control is not in operation, an optical disk never comes into contact with an objective lens. In addition, even though it is subjected to a strong disturbance, an optical disk is not damaged. In other words, a superior optical disk apparatus is provided which enhances, simply and easily at a low cost, the long-term reliability of recording data. Moreover, even when the power is kept turned off and an optical disk remains inserted in the apparatus, the optical disk does not come into contact with the protective member. This prevents an optical disk from being dirtied and damaged because of the long-term contact of the optical disk with the protective member, as is often the case with a conventional apparatus.

These and other objects, features and advantages of the present invention will become more apparent upon reading of the following detailed description along with the accompanied drawings.

### BRIEF DESCRIPTION OF THE DRAWINGS

FIG. 1A is a side sectional view of an example of a cartridge which is used for an optical disk apparatus according to a first embodiment of the present invention. FIG. 1B is a bottom view of the example of the cartridge.

FIG. 2 is a side sectional view of the cartridge 2 shown in FIG. 1A, seen in the central direction of an optical disk 1 from the end part of a rib 2b of the cartridge 2.

FIG. 3 is a side sectional view of the optical disk apparatus according to the first embodiment of the present invention, showing its configuration.

FIG. 4A is a side view of an example of a portable movie apparatus which the optical disk apparatus shown in FIG. 3 is applied to. FIG. 4B is a front view of the example of the movie apparatus.

FIG. 5A is a front view of the movie apparatus shown in FIGS. 4A and 4B, showing a state in which it is placed on its side such that an optical head is below an optical disk. FIG. 5B is a front view of the movie apparatus, showing a state in which it is placed on its side such that the optical head is above the optical disk.

FIG. 6 is a side sectional view of an optical disk apparatus according to a second embodiment of the present invention, showing its configuration.

FIG. 7A is a flow chart, describing an operation of the optical disk apparatus shown in FIG. 6, when a demand to turn on its power has been made. FIG. 7B is a flow chart, describing an operation of the optical disk apparatus, when a demand to turn off the power has been made.

FIG. 8 is a side sectional view of an optical disk apparatus according to a third embodiment of the present invention, showing its configuration.

FIG. 9 is a side sectional view of an objective lens and a protective ring, describing a case in which they are united.

FIG. 10 is a side sectional view of an optical disk and an objective lens, showing a conventional example in which they are disposed.

FIG. 11 is a side sectional view of a conventional optical disk apparatus, showing a state in which an optical disk is in contact with an objective lens.

### DETAILED DESCRIPTION OF INVENTION

Hereinafter, embodiments of the present invention will be described with reference to the accompanied drawings.

(First Embodiment)

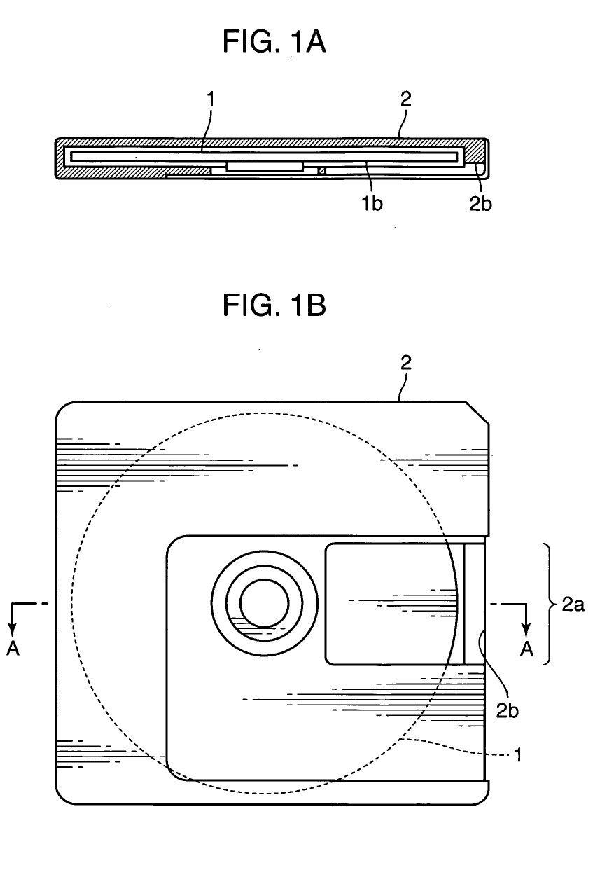

FIG. 1A to FIG. 3 show the optical disk apparatus according to a first embodiment of the present invention.

FIG. 1 shows a sectional view of an example of a cartridge which houses an optical disk. FIG. 1A is a sectional view of the cartridge shown in FIG. 1B, seen along an A-A line. FIG. 1B is a bottom view of the cartridge shown in FIG. 1A. In FIG. 1A and FIG. 1B, reference numeral 1 denotes an optical disk, which is the same as the prior arts. Reference numeral 2 denotes a cartridge which has the optical disk 1 inside. In the cartridge 2, an opening portion 2a is provided which an optical head including an objective lens accesses the optical disk 1 through. At its peripheral-side end-part, there is a rib 2b. As shown in FIG. 1A, the plane of the rib 2b on the side of an objective lens 4 is set so that it is substantially on the same plane with a plane 1b (i.e., the plane which light is incident upon) of the optical disk 1 on the side of its access to the objective lens 4 during its operation.

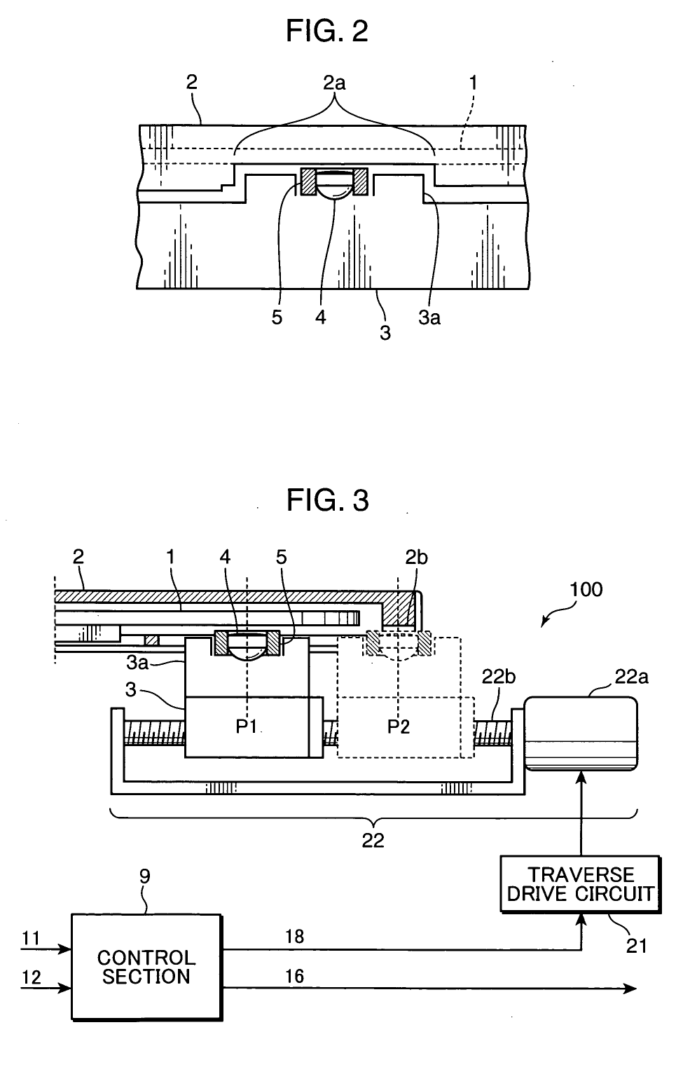

FIG. 2 is a side sectional view of the cartridge 2 shown in FIG. 1A, seen in the central direction of the optical disk 1 from the end part of the rib 2b of the cartridge 2. The objective lens 4, and a protective ring (or protective member) 5 which is provided around the objective lens 4 and whose upper plane is located above the objective lens 4, are the same as the prior arts. The objective lens 4 converges and applies a laser beam onto the optical disk 1. The protective ring 5 is disposed out of the optical effective range of the objective lens 4 and protrudes on the side of the optical disk 1 from the objective lens 4, so that it protects the objective lens 4. The part of the protective ring 5 which protrudes on the side of the optical disk 1 from the objective lens 4 has a concentric-circle ring shape along the periphery of the objective lens 4. The protective ring 5 is made, preferably, of a resin material or the like which rubs and moves.

Herein, the shape of the part of the protective ring 5 which protrudes on the side of the optical disk 1 from the objective lens 4 is not limited to the one described above. For example, it may also be shaped such that several semi-spherical convex portions protrude on the side of the optical disk 1 from the objective lens 4 along the periphery of the objective lens 4. Any shapes may also be used, as long as it is disposed out of the optical effective range of the objective lens 4 and protrudes on the side of the optical disk 1 from the objective lens 4 so that it can protect the objective lens 4.

Reference numeral 3 denotes an optical head, which holds the objective lens 4. Near the objective lens 4, an objective-lens actuator portion (or focusing mechanism) 3a is disposed. It executes a focusing operation and a tracking operation by driving the objective lens 4 slightly in the directions perpendicular to the plane of the optical disk 1 and in the radius directions thereof so that the objective lens 4 can follow a plane shake of the optical disk 1 or its deviation from the center (or decentration).

The objective lens 4, the protective ring 5 and the objective-lens actuator portion 3a, as shown in the figure, have the sizes so that they can fit into the opening portion 2a. This helps improve the space factor of the optical head 3.

The cartridge 2 which has such a characteristic is configured so that it can be loaded irrespective of its top or bottom. A means of doing that is shown, for example, in Japanese Patent Laid-Open No. 5-189917 specification, and thus, this will not hurt, particularly, generality or practicability.

FIG. 3 is a side sectional view of the optical disk apparatus according to the first embodiment of the present invention, showing its configuration. An optical disk apparatus 100 according to the first embodiment shown in FIG. 3 is configured by: the objective lens 4; the protective ring 5; a control section 9; a traverse drive circuit 21; and a traverse mechanism 22.

The objective lens 4 can access the position beyond the peripheral side of the optical disk 1 using the traverse mechanism 22. It can move up to a position P2 which faces the rib 2b shown in the figure.

The traverse mechanism 22 is a mechanism which moves, using a well-known screw feed mechanism, the optical head 3 in the radius directions of the optical disk 1 so that it can access a desired track. It can move the optical head 3 in the peripheral direction, at least up to the position in which the objective lens 4 is below the rib 2b, or up to the position P2 shown in the figure. The traverse mechanism 22 includes a traverse motor 22a and a feed screw 22b. The traverse motor 22a is placed on the traverse mechanism 22 and rotates the feed screw 22b. The traverse drive circuit 21 drives the traverse motor 22a.

The control section 9 receives a power-on demand signal 11 and a power-off demand signal 12. It outputs a power-off signal 16 and a traverse control signal 18.

The power-on demand signal 11 can be an input, such as an input given when a user switches on and an input given from a program timer. The power-off demand signal 12 can be a switch input by a user, and in addition, in the same way, a timer input, or an input given from a controller for the purpose of saving power consumption.

The power-off signal 16 is outputted, for example, to a power-shutoff circuit (e.g., a power control IC) or the like. When this power-off signal 16 is turned on, the optical disk apparatus 100 is shut down, at least apart from stand-by power or the like. The traverse control signal 18 is outputted to the traverse drive circuit 21. This traverse control signal 18 is outputted, and thereby, the traverse drive circuit 21 moves the optical head 3 including the objective lens 4 to a target position in the radius directions of the optical disk 1. According to the traverse control signal 18, the traverse drive circuit 21 sends, to the traverse motor 22a, an electric current for a drive such as a movement in the inner-circumference direction, a movement in the outer-circumference direction, a stop, and the like.

Hereinafter, operations will be described of the optical disk apparatus 100 according to the first embodiment configured as described above.

First, an operation of the optical disk apparatus 100 will be described when its power is kept turned on and the optical head 3 is in a position P1. If the power-off demand signal 12 is active, then the control section 9 allows the traverse control signal 18 to generate a signal to move the optical head 3 up to the outer-circumference side, for example, up to the position P2. According to the traverse control signal 18, the traverse drive circuit 21 sends to the traverse motor 22a a drive electric-current for moving the optical head 3 up to the position P2. Then, the traverse motor 22a rotates the feed screw 22b to move the optical head 3 up to the position P2. Thereafter, in this state, the control section 9 turns on the power-off signal 16 to shut down the whole optical disk apparatus 100.

Next, an operation of the optical disk apparatus 100 will be described when its power is kept turned off and the optical head 3 is in the position P2 which faces the rib 2b. If the power-on demand signal 11 is active, then the control section 9 allows the traverse control signal 18 to generate a signal to move the optical head 3 up to the inner-circumference side, for example, up to the position P1. According to the traverse control signal 18, the traverse drive circuit 21 sends to the traverse motor 22a a drive electric-current for moving the optical head 3 up to the position P1. Then, the traverse motor 22a rotates the feed screw 22b to move the optical head 3 up to the position P1.

Then, the control section 9 brings the objective lens 4 into a state in which it can execute focusing and tracking operations. Thereafter, according to the operation immediately before the power is turned off, for example, an operation is executed, such as reading out the TOC (or table of contents) and standing by for replaying.

Thus, while information is replayed from the optical disk 1, the objective lens 4 is, for example, below the optical disk 1 and in the position P1 where it can execute ordinary access. In the same way as the prior arts, under an abnormal situation such as the accidental removal of servo control, the protective ring 5 helps avoid a bump between the optical disk 1 and the objective lens 4.

Furthermore, according to this embodiment, when the power is kept turned off, the objective lens 4 can be moved to the position P2. In this state, needless to say, the protective ring 5 helps prevent the objective lens 4 from hitting the optical disk 1. Besides, the protective ring 5 can also be prevented from hitting the optical disk 1. It bumps merely the rib 2b. Accordingly, even when the power is kept turned off and servo control is not in operation, the state in which there is nothing that may damage the optical disk 1 can be realized, regardless of any disturbances.

Moreover, the optical disk apparatus 100 includes at least: the objective lens 4 that converges and applies a laser beam onto the optical disk 1; the protective ring 5 that protects the objective lens 4, protrudes on the side of the optical disk 1 from the objective lens 4 and is disposed out of the optical effective range of the objective lens 4; and a traverse mechanism 22 that moves the objective lens 4 and the protective ring 5. It includes the rib 2b which is disposed outside of the periphery of the optical disk 1 and whose plane on the side of the objective lens 4 is substantially on the same plane with the plane of incidence of the optical disk 1. When the optical disk apparatus 100 is kept turned off, the traverse mechanism 22 moves the objective lens 4 and the protective ring 5 to the position that faces the plane of the rib 2b on the side of the objective lens 4. Accordingly, even when the power is kept turned off and the optical disk 1 remains inserted in the apparatus, the optical disk 1 does not come into contact with the protective ring 5. This prevents the optical disk 1 from being dirtied and damaged because of the long-term contact of the optical disk 1 with the protective ring 5, as is often the case with a conventional apparatus.

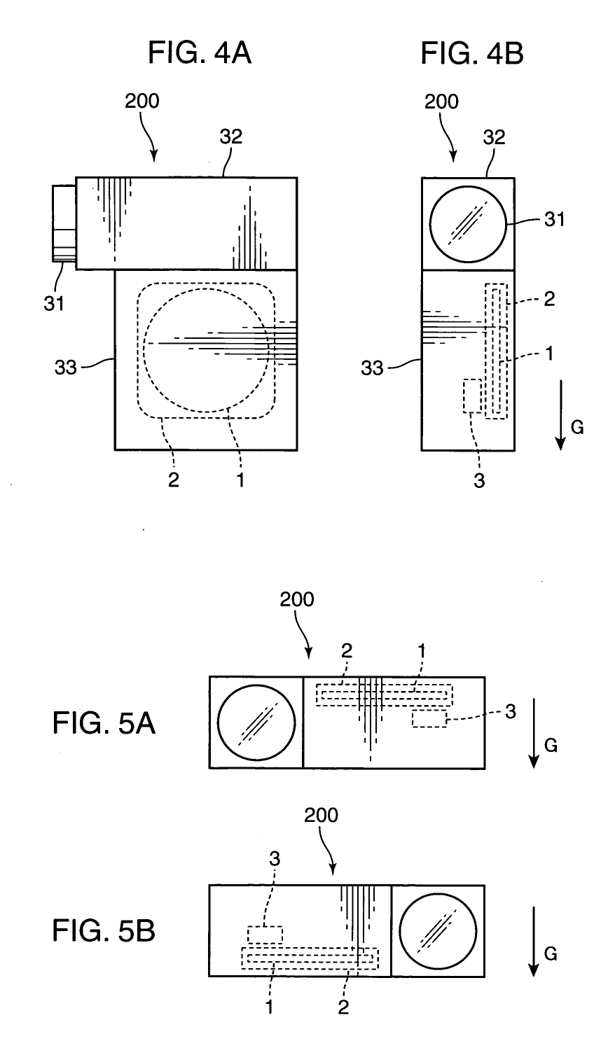

FIGS. 4A and 4B show examples of a portable movie apparatus which the optical disk apparatus shown in FIG. 3 is applied to. FIG. 4A is a side view of the movie apparatus, and FIG. 4B is a front view of the movie apparatus. FIGS. 5A and 5B show that the movie apparatus shown in FIGS. 4A and 4B is placed on its side. FIG. 5A shows a state in which an optical head is below an optical disk. FIG. 5B shows a state in which the optical head is above the optical disk. Herein, the arrows shown in FIG. 4B, FIG. 5A and FIG. 5B indicate the direction in which gravity G works.

A movie apparatus 200 shown in FIG. 4A and FIG. 4B is configured mainly by a lens 31, an optical portion 32, and a drive portion 33. In the drive portion 33, the optical disk 1, the cartridge 2 and the optical head 3 are housed. The drive portion 33 ordinarily has a rectangular-parallelepiped shape similar to that of the cartridge 2. This has come from an increasing demand for making the apparatus smaller and thinner.

For example, in the case of the portable movie apparatus 200, as described above, the drive portion 33 is designed to have a thin shape, in the same way as the cartridge 2. In this case, for example, as shown in FIG. 4B, it is rarely stored or left behind such that the direction in which gravity G works is parallel to the radius directions of the optical disk 1. If you store the movie apparatus 200 in this state, it becomes unstable and thus easy to bring down. Therefore, usually, as shown in FIG. 5A or FIG. 5B, it is stored or left behind on one of its sides. At this time, in the state shown in FIG. 5B, the optical head 3 is located above the optical disk 1, and thus, the objective lens 4 is displaced in the direction of gravity G. In other words, while it is ordinarily stored, the objective lens 4 is kept displaced at a probability of 50 percent in the direction of the optical disk 1. According to this embodiment, however, the protective ring 5 comes into contact only with the rib 2b. This prevents the protective ring 5 from being kept in contact with the optical disk 1, as is often the case with the prior arts described using FIG. 11.

Herein, according to this embodiment, the description has been given of the example in which the optical disk apparatus is applied to a movie apparatus. However, the present invention is not limited especially to this. Another piece of electrical equipment may also be used which replays an optical disk such as a CD and a DVD. Especially, it can be applied to portable electrical equipment.

In addition, the optical disk 1 is housed in the cartridge 2, and the rib 2b is formed near the outer-edge connection part of on outer-side of the opening portion 2a through which the objective lens 4 comes close to the optical disk 1. Therefore, the part near the outer-edge connection part of on outer-side of the opening portion 2a of the cartridge 2 which houses the optical disk 1 is used as the rib 2b. Hence, especially, there is no need to provide the rib 2b, thus cutting off the number of production processes for providing the rib 2b.

Herein, even though the optical disk 1 (or the cartridge 2) is not housed when the power is kept turned off and the objective lens 4 is in the position P2, no problem can occur particularly, though there is no interference with the rib 2b.

(Second Embodiment)

Next, description will be given of a second embodiment of the present invention. According to the first embodiment, for example, the objective lens needs to be moved, for example, from the position P1 to the position P2, after a demand to turn off the power is made and before the power is actually turned off. At that time, in a system which has an extremely narrow WD, when the objective lens 4 moves, the side of the protective ring 5 may hit the rib 2b. If this embodiment is applied, this disadvantage can be evaded.

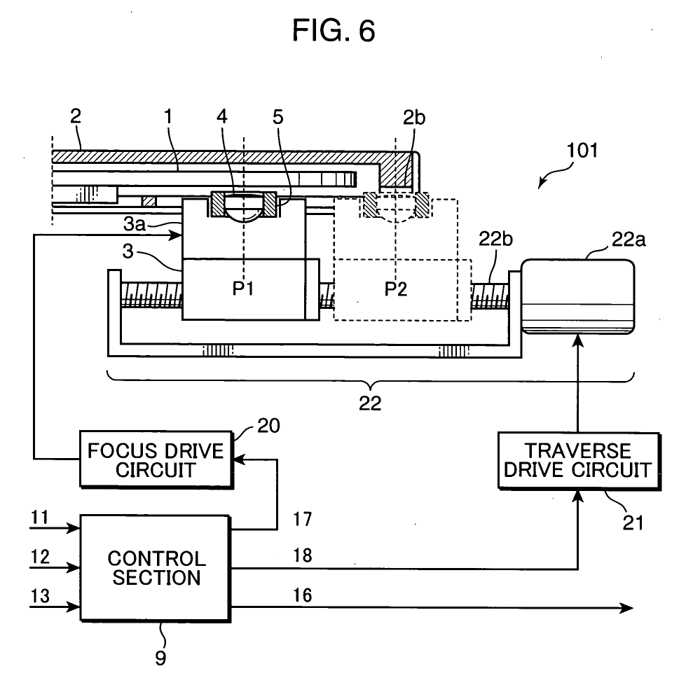

FIG. 6 shows the configuration of an optical disk apparatus according to the second embodiment of the present invention. An optical disk apparatus 101 according to the second embodiment shown in FIG. 6 is configured by: the objective lens 4; the protective ring 5; the control section 9; a focus drive circuit 20; the traverse drive circuit 21; and the traverse mechanism 22.

Herein, the optical disk 1, the cartridge 2, the optical head 3, the objective-lens actuator portion 3a, the objective lens 4, the protective ring 5, the traverse drive circuit 21, the traverse mechanism 22, and the like which are used in the following description are the same as those according to the first embodiment. Thus, their description is omitted.

The focus drive circuit 20 sends to the objective-lens actuator portion 3a an electric current for driving the objective lens 4 in the focus directions (i.e., in the directions perpendicular to the optical-disk plane).

The control section 9 receives the power-on demand signal 11, the power-off demand signal 12 and an operation state signal 13. It outputs the power-off signal 16, an objective-lens retreat signal 17 and the traverse control signal 18.

The power-on demand signal 11 can be an input, such as an input given when a user switches on and an input given from a program timer. The power-off demand signal 12 can be a switch input by a user, and in addition, in the same way, a timer input, or an input given from a controller for the purpose of saving power consumption. The operation state signal 13 is a state signal which shows an operation state, such as whether the optical disk apparatus 101 is on standby, or is replaying, or is recording, at present.

The power-off signal 16 is outputted, for example, to a power-shutoff circuit (e.g., a power control IC) or the like. When this power-off signal 16 is turned on, the optical disk apparatus 100 is shut down, at least apart from stand-by power or the like.

The objective-lens retreat signal 17 is outputted to the focus drive circuit 20. When the objective-lens retreat signal 17 is turned on, the focus drive circuit 20 drives the objective-lens actuator portion 3a, so that the objective lens 4 can be moved apart from the optical disk 1.

The traverse control signal 18 is outputted to the traverse drive circuit 21. This traverse control signal 18 is outputted, and thereby, the traverse drive circuit 21 moves the optical head 3 including the objective lens 4 to a target position in the radius directions of the optical disk 1.

Herein, the power-off signal 16 and the objective-lens retreat signal 17 are not turned on when the operation state signal 13 is indicating a recording state.

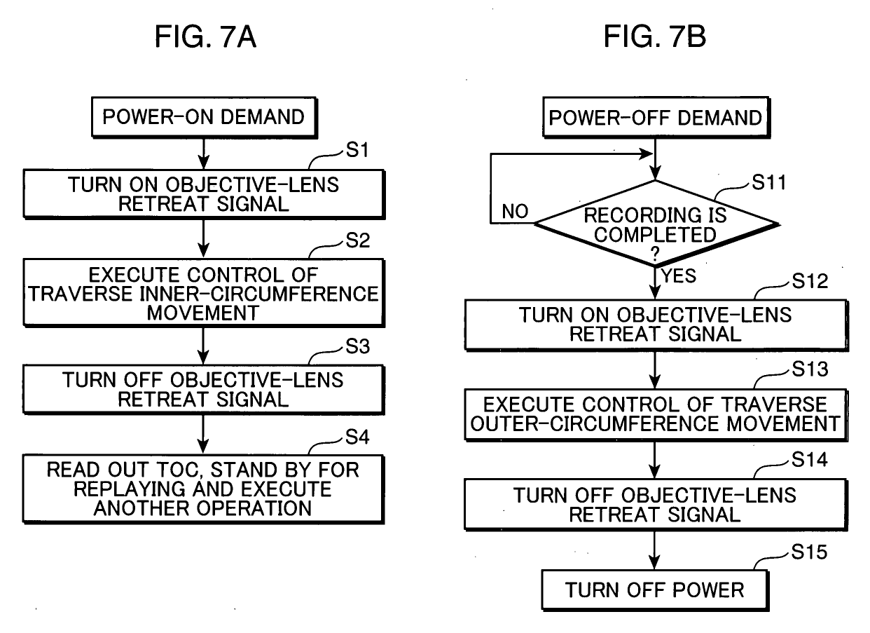

Hereinafter, operations of the optical disk apparatus 101 configured as described above based on FIG. 6, FIG. 7A and FIG. 7B. FIGS. 7A and 7B are flow charts, describing an operation of the optical disk apparatus shown in FIG. 6. FIG. 7A is a flow chart, describing an operation of the optical disk apparatus when a demand to turn on its power has been made. FIG. 7B is a flow chart, describing an operation of the optical disk apparatus when a demand to turn off the power has been made.

First, when the power is kept turned off, the objective lens 4 is assumed to be in the position P2 which faces the rib 2b. In FIG. 7A, if the power-on demand signal 11 becomes active, then the control section 9 turns on the objective-lens retreat signal 17 (in a step S1). According to the objective-lens retreat signal 17, the focus drive circuit 20 sends to the objective-lens actuator portion 3a an electric current for moving the objective lens 4 apart from the optical disk 1, so that the objective lens 4 in the position P2 is moved apart from the rib 2b. Then, the control section 9 allows the traverse control signal 18 to generate a signal to move the optical head 3 up to the inner-circumference side, for example, up to the position P1. According to the traverse control signal 18, the traverse drive circuit 21 sends to the traverse motor 22a a drive electric-current for moving the optical head 3 up to the position P1. Then, the traverse motor 22a rotates the feed screw 22b to move the optical head 3 up to the position P1 (in a step S2).

Thereafter, the control section 9 turns off the objective-lens retreat signal 17 and outputs that to the focus drive circuit 20 (in a step S3). The focus drive circuit 20 stops generating the electric current for retreating the objective lens 4 from the optical disk 1, so that the objective lens 4 can execute focusing and tracking operations. Thereafter, according to the operation immediately before the power is turned off, for example, an operation is executed, such as reading out the TOC and standing by for replaying (in a step S4).

Thus, aiming first at moving the objective lens 4 apart from the rib 2b, even if the rib 2b is in contact with the protective ring 5 before the power is turned on, the rib 2b does not rub against the protective ring 5. Besides, the protective ring 5 does not hit the periphery of the optical disk 1.

Furthermore, the objective-lens actuator portion 3a moves the objective lens 4 in the direction apart from the optical disk 1, after a demand to turn on the power is made when it is kept turned off and before the objective lens 4 is moved in the radius directions of the optical disk 1 from the position that faces the rib 2b. Therefore, the objective lens 4 can be prevented from rubbing against the rib 2b. Besides, the side plane of the objective lens 4 can be prevented from bumping the side plane of the optical disk 1. This certainly prevents the objective-lens actuator portion 3a or the like which drives the objective lens 4 from being damaged.

Next, an operation of the optical disk apparatus 101 will be described when its power is kept turned on and the optical head 3 is in the position P1. In FIG. 7B, if the power-off demand signal 12 is active, the control section 9 detects a recording operation based on the operation state signal 13. Then it judges whether or not the recording operation is completed (in a step S11). Only if the recording operation is completed, the control section 9 turns on the objective-lens retreat signal 17. Then, it controls the focus drive circuit 20 in the same way as described earlier, for example, so that the objective lens 4 in the position P1 is moved apart from the optical disk 1 (in a step S12). Thereafter, according to the traverse control signal 18, the control section 9 controls the traverse drive circuit 21 and the traverse mechanism 22 also in the same way as described earlier, and instructs them to send the optical head 3 to the position P2 (in a step S13).

The reason that the operation state signal 13 is confirmed is because if a demand to turn off the power is made when a recording operation is executed for the optical disk 1, first of all, the recording operation needs to be completed. In a general optical-disk recording operation, there is a time lag between input data from the outside and writing data onto the optical disk 1. This is because input data from the outside is once stored and recorded in a buffer before it is written onto the optical disk 1. In addition, when the writing is completed, in some cases, management information is written in a TOC area of the optical disk 1. Hence, according to this embodiment, such a series of operations before its completion are executed, and thereafter, the objective lens 4 is moved apart from the optical disk 1 up to the position P2.

Thus, the control section 9 receives at least the operation state signal 13 which shows whether or not information is being recorded, and if the control section 9 receives the power-off demand signal 12 when the operation state signal 13 shows that information is being recorded, then the control section 9 does not turn on the objective-lens retreat signal 17 until the operation state signal 13 changes and shows that information is not being recorded. Therefore, after information has been certainly recorded, the objective lens 4 is retreated. This makes the apparatus easier for a user to handle, and also heightens the reliability of information.

Then, the control section 9 turns off the objective-lens retreat signal 17 in the position P2 (in a step S14). As a result, the protective ring 5 may come into contact with the rib 2b. However, this is no problem at all, as described in the first embodiment. Then, in this state, the control section 9 turns on the power-off signal 16 to shut down the whole optical disk apparatus 101 (in a step S15).

Thus, even when the power is kept turned off, first of all, the objective lens 4 is moved apart from the optical disk 1. Therefore, in the process of moving the objective lens 4 from the position P1 to the position P2, the protective ring 5 does not bump against the rib 2b.

Moreover, the traverse mechanism 22 moves the objective lens 4 to the position which faces the rib 2b, after a demand to turn off the power is made and before the power is turned off. Therefore, before servo control comes into the state where it is not in operation, the objective lens 4 can be placed below the rib 2b. This makes it possible to certainly protect the objective lens 4 and the optical disk 1.

In addition, preferably, the objective-lens actuator portion 3a moves the objective lens 4 in the direction apart from the optical disk 1, before the objective lens 4 passes through the optical disk 1 and reaches the position that faces the rib 2b. Therefore, the side plane of the objective lens 4 can be prevented from bumping against the side plane of the rib 2b. This certainly prevents the objective-lens actuator portion 3a or the like which drives the objective lens 4 from being damaged.

Furthermore, the traverse mechanism 22 moves an optical system which includes the objective lens 4 in substantially the radius directions of the optical disk 1. The optical disk apparatus 101 further includes the control section 9 which receives at least the power-on demand signal 11 to demand that the power be turned on and the power-off demand signal 12 to demand that the power be turned off, and which outputs the power-off signal 16 to turn off the power, the objective-lens retreat signal 17 to move the objective lens 4 apart from the optical disk 1, and the traverse control signal 18 to control the traverse mechanism 22. If the control section 9 receives the power-off demand signal 12 when the power of the optical disk apparatus 101 is turned on, then the control section 9 turns on the objective-lens retreat signal 17 to move the objective lens 4 apart from the optical disk 1. Thereafter, it outputs to the traverse mechanism 22 the traverse control signal 18 to move the objective lens 4 fully up to the side of the outer circumference of the optical disk 1. Then, it turns off the objective-lens retreat signal 17 after the objective lens 4 is placed in the position that faces the rib 2b, and outputs the power-off signal 16 to turn off the power of the optical disk apparatus 101. If the control section 9 receives the power-on demand signal 11 when the power of the optical disk apparatus 101 is kept turned off, then the control section 9 turns on the objective-lens retreat signal 17 to move the objective lens 4 apart from the rib 2b. Thereafter, it outputs to the traverse mechanism 22 the traverse control signal 18 to move the objective lens 4 in the direction of the inner circumference of the optical disk 1. Then, it turns off the objective-lens retreat signal 17 after the objective lens 4 is moved in the inner-circumference direction of the optical disk 1.

Therefore, before and after the traverse mechanism 22 moves, the control section 9 controls the objective-lens retreat signal 17 to retreat the objective lens 4 from the optical disk 1 or the rib 2b, according to whether the power of the optical disk apparatus 101 is turned on. This can protect securely and automatically the objective lens 4 and the optical disk 1, regardless of the state of the apparatus's power.

(Third Embodiment)

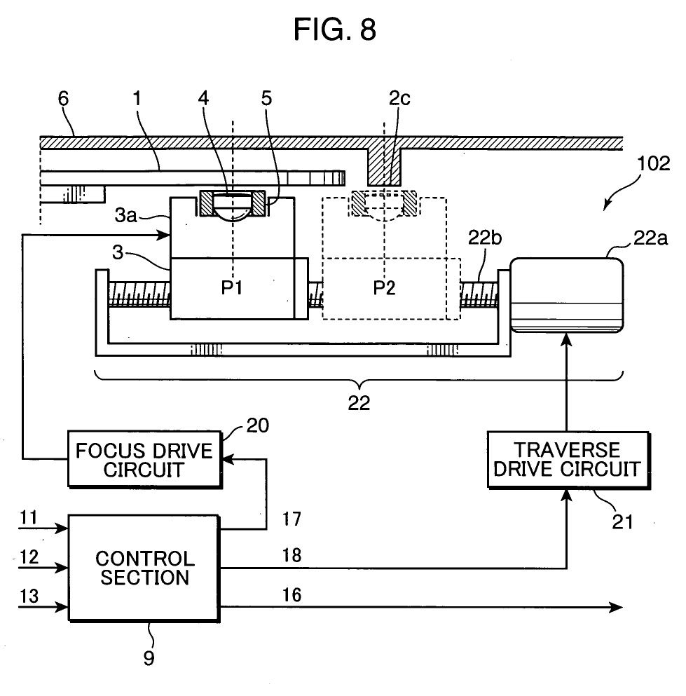

Next, description will be given of a third embodiment of the present invention. In the optical disk apparatuses 100, 101 according to the above described first and second embodiments, the cartridge 2 is used which houses the optical disk 1. However, in the optical disk apparatus according to the third embodiment, the optical disk 1 is only used. FIG. 8 shows the configuration of an optical disk apparatus according to the third embodiment of the present invention. Herein, the configuration of an optical disk apparatus 102 shown in FIG. 8 is substantially the same as the configuration of the optical disk apparatus 101 according to the second embodiment shown in FIG. 6. Hence, description will be given only of the parts which are different from the configuration of the optical disk apparatus 101 according to the second embodiment shown in FIG. 6.

In the optical disk apparatus 102 shown in FIG. 8, a rib 2c is formed by protruding a part of a main body 6. The rib 2c is located outside of the periphery of the optical disk 1. The rib 2c formed in the main body 6 of the optical disk apparatus 102 functions in the same way as the rib 2b according to the first and second embodiments. When the power of the optical disk apparatus 102 is turned off, the traverse mechanism 22 moves the objective lens 4 and the protective ring 5 to the position which faces the plane of the rib 2c on the side of the objective lens 4. Herein, operations of the optical disk apparatus 102 according to the third embodiment are the same as those of the optical disk apparatus 101 according to the second embodiment, and thus, their description is omitted.

Thus, the optical disk 1 is not housed in the cartridge 2, and even when the power is kept turned off and servo control is not in operation, the optical disk 1 never comes into contact with the objective lens 4. In addition, even though it is subjected to a strong disturbance, the optical disk 1 is not damaged. In other words, the superior optical disk apparatus 102 is provided which enhances, simply and easily at a low cost, the long-term reliability of recording data. Moreover, even when the power is kept turned off and the optical disk 1 remains inserted in the apparatus, the optical disk 1 does not come into contact with the protective ring 5. This prevents the optical disk 1 from being dirtied and damaged because of the long-term contact of the optical disk 1 with the protective ring 5, as is often the case with a conventional optical disk apparatus.

Herein, the present invention is effective in an optical disk apparatus which has a high NA, for example, any apparatuses such as high-density read-only, phase-change, and magneto optical disk apparatuses. It is very effective especially in a portable optical disk apparatus.

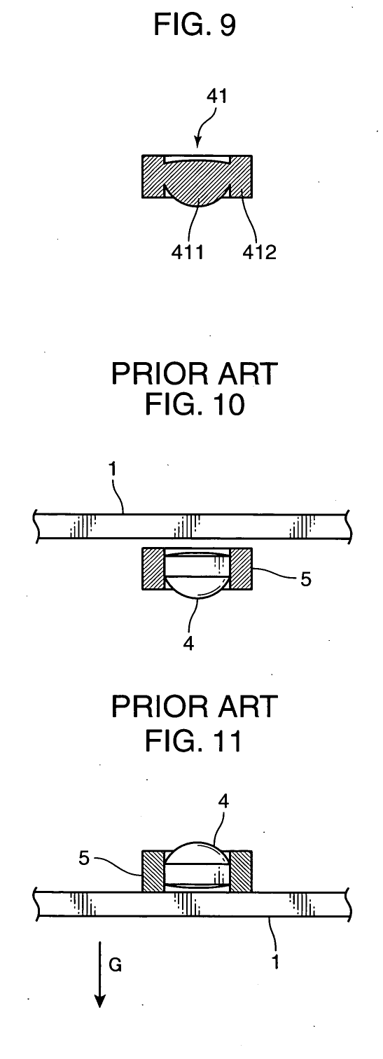

Furthermore, according to this embodiment, the objective lens 4 and the protective ring 5 are formed individually. However, the present invention is not limited especially to this. The objective lens 4 and the protective ring 5 may also be united. FIG. 9 is a side sectional view of an objective lens and a protective ring, describing a case in which they are united. As shown in FIG. 9, an objective lens 41 is made up of a lens part 411 and a protective ring part 412. The lens part 411 converges and applies a laser beam onto the optical disk 1. The protective ring part 412 protrudes on the side of the optical disk 1 from the lens part 411 and protects the lens part 411. In this case, the objective lens 4 and the protective ring 5 can be produced at a time, thereby reducing the number of processes for producing the apparatus. Besides, the objective lens 4 and the protective ring 5 are united, and thus, the protective ring 5 can be prevented from falling off the objective lens 4.

Moreover, a screw feed mechanism is mentioned as an example of the traverse mechanism 22. However, the present invention is not limited to this example. A voice coil motor, an ultrasonic motor, or the like, can be optionally configured.

In addition, a position sensor may also be provided which is used when the optical head 3 is located in the position P2. Thus, a signal from this position sensor is inputted in the control section 9 and is used for control of the traverse control signal 18. In that case, the optical head 3 can be located more certainly.

Furthermore, according to this embodiment, as a means of moving the objective lens 4 to the rib 2b, the whole optical head 3 is moved by the traverse mechanism 22. However, for example, as a broad-sense traverse mechanism, the objective-lens actuator portion 3a itself may also have that function. Besides, theoretically, a part of the optical head 3 can also be separated to move the objective lens 4 to the rib 2b. In that case, not the whole optical head 3 but merely a part of it is moved. This helps realize an optical disk apparatus which has a better space factor.

The optical disk apparatus according to the present invention is capable of certainly preventing an optical disk from coming into contact with an objective lens, even when its power is kept turned off and servo control is not in operation, and preventing an optical disk from hitting the objective lens, even though it undergoes a strong disturbance. It is useful as an optical disk apparatus or the like which includes at least: an objective lens that converges and applies a laser beam onto an optical disk; a protective member that protects the objective lens, protrudes on the side of the optical disk from the objective lens and is disposed out of the optical effective range of the objective lens; and a traverse mechanism that moves the objective lens and the protective member.

This application is based on Japanese patent application serial No. 2003-105066 filed on Apr. 9, 2003 and No. 2004-65412 filed on Mar. 9, 2004 in Japanese Patent Office, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical disk apparatus, which includes at least an objective lens that converges and applies a laser beam onto an optical disk, a protective member that protects the objective lens, protrudes on the side of the optical disk from the objective lens and is disposed out of an optical effective range of the objective lens, and a traverse mechanism that moves the objective lens and the protective member, comprising,
a rib which is disposed outside of the periphery of the optical disk and whose plane on the side of the objective lens is substantially on the same plane with the plane of incidence of the optical disk,
wherein, when the optical disk apparatus is turned off, the traverse mechanism moves the objective lens and the protective member to the position that faces the plane of the rib on the side of the objective lens.

2. The optical disk apparatus according to claim 1, wherein:
the optical disk is housed in a cartridge having an opening portion through which the objective lens comes close to the optical disk; and
the rib is formed near an outer-edge connection part of on outer-side of the opening portion.

3. The optical disk apparatus according to claim 1, wherein the rib is formed in a main body of the optical disk apparatus.

4. The optical disk apparatus according to claim 1, wherein the traverse mechanism moves the objective lens to the position which faces the rib, after a demand to turn off the power is made and before the power is turned off.

5. The optical disk apparatus according to claim 1, further comprising a focusing mechanism which moves the objective lens in the direction apart from the optical disk, before the objective lens passes through the optical disk and reaches the position that faces the rib.

6. The optical disk apparatus according to claim 1, further comprising a focusing mechanism which moves the objective lens in the direction apart from the optical disk, after a demand to turn on the power is made when it is turned off and before the objective lens is moved in the radius directions of the optical disk from the position that faces the rib.

7. The optical disk apparatus according to claim 1, wherein:
the traverse mechanism moves an optical system which includes the objective lens in substantially the radius directions of the optical disk;
the optical disk apparatus further comprises a control section which receives a power-on demand signal and a power-off demand signal, and which outputs a power-off signal to turn off the power, an objective-lens retreat signal to move the objective lens apart from the optical disk, and a traverse control signal to control the traverse mechanism;
if the control section receives the power-off demand signal when the power of the optical disk apparatus is turned on, then the control section turns on the objective-lens retreat signal to move the objective lens apart from the optical disk, thereafter, outputs to the traverse mechanism the traverse control signal to move the objective lens fully up to the side of the outer circumference of the optical disk, turns off the objective-lens retreat signal after the objective lens is placed in the position that faces the rib, and outputs the power-off signal to turn off the power of the optical disk apparatus; and
if the control section receives the power-on demand signal when the power of the optical disk apparatus is turned off, then the control section turns on the objective-lens retreat signal to move the objective lens apart from the rib, thereafter, outputs to the traverse mechanism the traverse control signal to move the objective lens in the direction of the inner circumference of the optical disk, and turns off the objective-lens retreat signal after the objective lens is moved in the inner-circumference direction of the optical disk.

8. The optical disk apparatus according to claim 7, wherein the control section receives an operation state signal which shows whether or not information is being recorded, and if the control section receives the power-off demand signal when the operation state signal shows that information is being recorded, then the control section does not turn on the objective-lens retreat signal until the operation state signal changes and shows that information is not being recorded.

9. The optical disk apparatus according to claim 1, wherein the objective lens and the protective member are united.
